(19) United States
(12) Patent Application Publication
(10) Pub. No.: US 2018/0335814 A1
(43) Pub. Date: Nov. 22, 2018

(54) SHIFT REGISTER UNIT, GATE DRIVE CIRCUIT AND DISPLAY APPARATUS HAVING THE SAME, AND DRIVING METHOD THEREOF

(71) Applicants: BOE TECHNOLOGY GROUP CO., LTD.; HEFEI BOE OPTOELECTRONICS TECHNOLOGY CO., LTD.

(72) Inventors: Xianjie Shao, Beijing (CN); Junsheng Chen, Beijing (CN)

(73) Assignees: BOE TECHNOLOGY GROUP CO., LTD., Beijing (CN); HEFEI BOE OPTOELECTRONICS TECHNOLOGY CO., LTD., Hefei (CN)

(21) Appl. No.: 15/529,957

(22) PCT Filed: Nov. 8, 2016
(86) PCT No.: PCT/CN2016/105070

§ 371 Date: May 25, 2017

(30) Foreign Application Priority Data
Jun. 28, 2016 (CN) 201610494421.3

(51) Int. Cl. G06F 1/24

(52) U.S. Cl. CPC G06F 1/24

(57) ABSTRACT

The present application discloses a shift register unit and driving method, a gate drive circuit, and a display apparatus. The shift register unit includes a pull-up control sub-circuit configured to pass an input signal to a pull-up node to control a pull-up sub-circuit to output a clock signal to an output port as a gate drive signal for the display apparatus. The shift register unit further includes a pull-down control sub-circuit to pull down potential of the pull-down node to logic low. Additionally, the shift register unit includes a noise-reduction sub-circuit controlled by the pull-down node potential to respectively pull down the potentials of the pull-up node and the output port to logic low. Furthermore, the shift register unit includes a reset sub-circuit controlled by a reset signal to respectively pull down and maintain a logic low potential at the pull-up node and the output port, reducing noise thereof.

### CROSS-REFERENCE TO RELATED APPLICATION

This application claims priority to Chinese Patent Application No. 201610494421.3, filed Jun. 28, 2016, the contents of which are incorporated by reference in the entirety.

### TECHNICAL FIELD

The present invention relates to display technology field, particularly, to a shift register unit, a gate drive circuit and a display apparatus having the same, and a driving method thereof.

### BACKGROUND

Image display apparatuses include a driver for controlling image display in each of a plurality of pixels. The driver is a transistor-based circuit including a gate driving circuit and a data driving circuit. The gate driving circuit is primarily formed by cascading multiple units of shift register circuits. Each shift register unit outputs a gate driving signal to one of a plurality of gate lines of pixel transistors. The gate driving signals from the gate driving circuit scan through gate lines row by row, controlling each row of transistors to be in on/off states. The gate drive circuit can be integrated into a gate on array (GOA) circuit, which can be formed directly in the array substrate of the display panel.

### SUMMARY

In one aspect, the present disclosure provides a shift register unit circuit having an input port, a pull-up node, and an output port, and further comprising a pull-up control sub-circuit connected to the input port and the pull-up node and configured to be controlled by an input signal at the input port to output the input signal from the input port to the pull-up node to set a potential level at the pull-up node; a pull-up sub-circuit connected to the pull-up node, a first clock input port, and the output port and configured to be controlled by the potential level at the pull-up node to output a first clock signal from the first clock port to the output port; a pull-down control sub-circuit connected to a second clock input port, a pull-down node, and a first-voltage port and configured to be controlled by a second clock signal at the second clock input port and the potential level at the pull-up node to pull down a potential level at the pull-down node to a first voltage provided at the first-voltage port; a noise-reduction sub-circuit connected to the pull-down node, the pull-up node, the output port, and the first-voltage port and configured to pull down potential levels at the pull-up node and the output port to the first voltage; a reset sub-circuit connected to a reset port, the pull-up node, the output port, and the first-voltage port and configured to be controlled by a reset signal at the reset port to pull down the potential levels at the pull-up node and the output port to the first voltage; wherein the pull-up control sub-circuit comprises a first transistor having a gate and a first terminal commonly connected to the input port and a second terminal connected to the pull-up node.

Optionally, the pull-down control sub-circuit comprises a third transistor, a fourth transistor, a fifth transistor, a sixth transistor, and a second capacitor, the third transistor having a gate and a first terminal commonly connected to the second clock input port, and a second terminal connected to a gate of the fourth transistor; the fourth transistor having a first terminal connected to the second clock input port and a second terminal connected to the pull-down node; the fifth transistor having a gate connected to the pull-up node, a first terminal connected to the second terminal of the third transistor, and a second terminal connected to the first-voltage port; the sixth transistor having a gate connected to the pull-up node, a first terminal connected to the pull-down node, and a second terminal connected to the first-voltage port; and the second capacitor having one terminal connected to the pull-down node and another terminal connected to the first-voltage port.

Optionally, the pull-up sub-circuit comprises a second transistor and a first capacitor, the second transistor having a gate connected to the pull-up node, a first terminal connected to the first clock input port, and a second terminal connected to the pull-down node, the first capacitor having one terminal connected to the pull-up node and another terminal connected to the output port.

Optionally, the noise reduction sub-circuit comprises a seventh transistor and an eighth transistor, the seventh transistor having a gate connected to the pull-down node, a first terminal connected to the pull-up node, and a second terminal connected to the first-voltage port; the eighth transistor having a gate connected to the pull-down node, a first terminal connected to the input port, and a second terminal connected to the first-voltage port.

Optionally, the reset sub-circuit comprises a ninth transistor and a tenth transistor the ninth transistor having a gate connected to the reset port, a first terminal connected to the pull-up node, and a second terminal connected to the first-voltage port; the tenth transistor having a gate connected to the reset port, a first terminal connected to the output port, and a second terminal connected to the first-voltage port.

Optionally, the first clock input port and the second clock input port respectively receive a first clock signal and a second clock signal, the second clock signal being configured to be same in frequency and amplitude as the first clock signal but reverse in phase in multiple periods of a display cycle.

In another aspect, the present disclosure provides a gate drive circuit comprising a plurality of the shift register unit circuits described herein cascaded one after another in multiple stages from a first stage to a last stage, wherein the shift register unit circuit in the first stage includes an input port configured to receive a start signal; wherein the shift register unit circuit in each corresponding stage except the first stage includes an input port connected to an output port of a shift register unit circuit in a previous adjacent stage; wherein the shift register unit circuit in each corresponding stage except the last stage includes an output port connected to a reset port of a shift register unit circuit in a next adjacent stage; wherein the shift register unit circuit in the last stage includes a reset port configured to receive a reset signal, wherein the shift register unit in each corresponding stage includes a first clock input port and a second clock input port configured to be alternatively connected to a first system clock terminal and a second system clock terminal.

Optionally, the second clock signal is configured to be same in frequency and amplitude as the first clock signal but reverse in phase through a full time span of a display cycle.

Optionally, the shift register unit circuit in the last stage includes a reset port configured to receive the start signal.

Optionally, the gate drive circuit further comprises a phase inverter having a first input receiving an output signal from the output port of the shift register unit circuit in the last stage, a second input receiving a logic low potential provided at the first-voltage port, and being configured to output a reset signal to the reset port of the shift register unit circuit in the last stage, the reset signal being inverted in phase versus the output signal for resetting the output port of the shift register unit circuit in the last stage

In another aspect, the present disclosure provides a display apparatus comprising a gate drive circuit described herein.

In another aspect, the present disclosure provides a method for driving the shift register unit circuit described herein for generating a gate drive signal at the output port in a plurality of image display cycles, wherein each display cycle includes sequentially an input period, an output period, a reset period, a noise-reduction period, and a noise-maintaining period, the method comprising controlling the pull-up control sub-circuit to output the logic high potential to the pull-up node, using an input signal provided with a logic high potential at the input port in the input period; storing the logic high potential in a first capacitor of the pull-up sub-circuit; controlling the pull-up sub-circuit to output the first clock signal at a logic low potential from the first clock input port to the output port, using the logic high potential at the pull-up node in the input period; controlling the pull-up sub-circuit to output the first clock signal at a logic high potential from the first clock input port to the output port, using the logic high potential stored at the first capacitor to charge up the pull-up node to a higher logic high potential in the output period; outputting a logic high potential as the gate drive signal from the output port; controlling the pull-down control sub-circuit to output a logic high potential from the second clock input port to the pull-down node, using a second clock signal at a logic high potential provided at the second clock input port and a logic low potential at the pull-up node in the reset period; storing the logic high potential associated with the second clock signal in a second capacitor of the pull-down control sub-circuit; controlling the noise-reduction sub-circuit to respectively pull down the pull-up node and the output port to a logic low potential provided at the first-voltage port, using the stored logic high potential at the pull-down node; controlling the reset sub-circuit to respectively pull down the pull-up node and the output port to the logic low potential provided at the first-voltage port, using a reset signal at a logic high potential provided at the reset port in the reset period; outputting the logic high potential stored in the second capacitor to the pull-down node in the noise-reduction period; controlling the noise-reduction sub-circuit to respectively pull down the pull-up node and the output port to the logic low potential provided at the first-voltage port, using the logic high potential at the pull-down node; controlling the pull-down control sub-circuit to output the logic high potential associated with the second clock signal from the second clock input port to the pull-down node, using the second clock signal at a logic high potential provided at the second clock input port and a logic low potential at the pull-up node in the noise-maintaining period; storing the logic high potential in the second capacitor, and controlling the noise-reduction sub-circuit to respectively pull down the pull-up node and the output port to the logic low potential provided at the first-voltage port, using the logic high potential at the pull-down node.

Optionally, the method further comprises optionally repeating supplies of the input signal, the reset signal, the first clock signal, and the second clock signal at respective logic low or high potentials in a noise-reduction period followed by a subsequent noise-maintaining period before a next display cycle to maintain the output port at a state without outputting the gate drive signal.

Optionally, the shift register unit circuit described herein comprises a plurality of thin-film transistors, each thin-film transistor being a N-type transistor, wherein the input period is associated with a logic low potential provided at the first clock input port, a logic high potential provided at the second clock input port, a logic high potential inputted from the input port, wherein in the input period the pull-up node is correspondingly set to a logic high potential, the pull-down node is correspondingly set to a logic low potential, and the output port outputs a logic low potential; wherein any of the logic high potential is configured to be applied to a gate of a corresponding one of the plurality of thin-film transistors to make the corresponding one transistor in an on-state for conducting a current from a first terminal to a second terminal of the transistor, wherein any of the logic low potentials is configured to be applied to a gate of a corresponding one of the plurality of thin-film transistors to make the corresponding one transistor in an off-state for blocking a current from a first terminal to a second terminal of the transistor.

Optionally, the output period is associated with a logic high potential provided at the first clock input port, a logic low potential provided at the second clock input port, a logic low potential inputted from the input port, wherein in the output period the pull-up node is correspondingly set to a logic high potential, the pull-down node is correspondingly set to a logic low potential, and the output port outputs a logic high potential as a gate drive signal, wherein the logic high potential in the output period is bootstrapped to be higher than the logic high potential in the input period by the first capacitor of the pull-up sub-circuit.

Optionally, the reset period is associated with a logic low potential provided at the first clock input port, a logic high potential provided at the second clock input port, a logic low potential inputted from the input port, wherein in the reset period the pull-up node is correspondingly set to a logic low potential, the pull-down node is correspondingly set to a logic high potential, and the output port outputs a logic low potential.

Optionally, the noise-reduction period is associated with a logic high potential provided at the first clock input port, a logic low potential provided at the second clock input port, a logic low potential inputted from the input port, wherein in the noise-reduction period the pull-up node is correspondingly set to a logic low potential, the pull-down node is correspondingly set to a logic high potential, and the output port outputs a logic low potential, wherein the logic high potential at the pull-down node is provided from charges stored in the second capacitor of the pull-down control sub-circuit.

Optionally, the noise-maintaining period is associated with a logic low potential provided at the first clock input port, a logic high potential provided at the second clock input port, a logic low potential inputted from the input port, wherein in the noise-reduction period the pull-up node is correspondingly set to a logic low potential, the pull-down node is correspondingly set to a logic high potential, and the output port outputs a logic low potential, wherein the logic high potential at the pull-down node is provided from charges stored in the second capacitor of the pull-down control sub-circuit.

### BRIEF DESCRIPTION OF THE FIGURES

The following drawings are merely examples for illustrative purposes according to various disclosed embodiments and are not intended to limit the scope of the present invention.

FIG. 1 is a circuit structure diagram of a shift register unit according to some embodiments.

FIG. 2 is a circuit diagram of the shift register unit showing corresponding sub-circuits according to a specific embodiment.

FIG. 3 is a timing diagram for operating the shift register unit of FIG. 2 in one display cycle according to some embodiments.

FIG. 4 is a schematic diagram showing on/off states of the shift register unit of FIG. 2 during a period P1 of FIG. 3.

FIG. 5 is a schematic diagram showing on/off states of the shift register unit of FIG. 2 during a period P2 of FIG. 3.

FIG. 6 is a schematic diagram showing on/off states of the shift register unit of FIG. 2 during a period P3 of FIG. 3.

FIG. 7 is a schematic diagram showing on/off states of the shift register unit of FIG. 2 during a period P4 of FIG. 3.

FIG. 8 is a schematic diagram showing on/off states of the shift register unit of FIG. 2 during a period P5 of FIG. 3.

FIG. 9 is a structure diagram of a gate drive circuit according to some embodiments.

FIG. 10 is a structure diagram of another gate drive circuit according to some embodiments.

### DETAILED DESCRIPTION

The disclosure will now be described more specifically with reference to the following embodiments. It is to be noted that the following descriptions of some embodiments are presented herein for purpose of illustration and description only. It is not intended to be exhaustive or to be limited to the precise form disclosed.

Typical gate drive circuits use a Gate Driver on Array (GOA) design to integrate a plurality of thin-film transistors (TFT)-based gate switch sub-circuits in a peripheral area of a display panel. Each gate switch sub-circuit is a one-stage shift register circuit of the GOA circuit. Each shift register circuit includes an output port connected to a corresponding gate line. When gate lines are scanned from one row to another, a gate line currently being scanned receives a gate control voltage from the output port of the shift register unit connected to the gate line. Other shift register units that are not connected to the gate line currently being scanned are in idle states so that the output ports of these shift register units have no output signals. Due to circuit structure of the shift register unit and coupling capacitance of the internal driving transistor, charges stored at several circuit nodes of the shift register unit and driving transistor cannot be fully released even when the shift register unit is in an “idle” state. Thus, the shift register units in the idle state will introduce noise through their output ports, reducing GOA circuit stability.

Accordingly, the present invention provides, inter alia, a shift register unit, a gate drive circuit and a display apparatus having the same, and a driving method thereof that substantially obviate one or more of the problems due to limitations and disadvantages of the related art. In one aspect, the present disclosure provides a shift register unit circuit having an input port, a pull-up node, and an output port. In some embodiments, the shift register unit circuit includes a pull-up control sub-circuit connected to the input port and the pull-up node and configured to be controlled by an input signal at the input port to output the input signal from the input port to the pull-up node to set a potential level at the pull-up node; a pull-up sub-circuit connected to the pull-up node, a first clock input port, and the output port and configured to be controlled by the potential level at the pull-up node to output a first clock signal from the first clock port to the output port; a pull-down control sub-circuit connected to a second clock input port, a pull-down node, and a first-voltage port and configured to be controlled by a second clock signal at the second clock input port and the potential level at the pull-up node to pull down a potential level at the pull-down node to a first voltage provided at the first-voltage port; a noise-reduction sub-circuit connected to the pull-down node, the pull-up node, the output port, and the first-voltage port and configured to pull down potential levels at the pull-up node and the output port to the first voltage; and a reset sub-circuit connected to a reset port, the pull-up node, the output port, and the first-voltage port and configured to be controlled by a reset signal at the reset port to pull down the potential levels at the pull-up node and the output port to the first voltage.

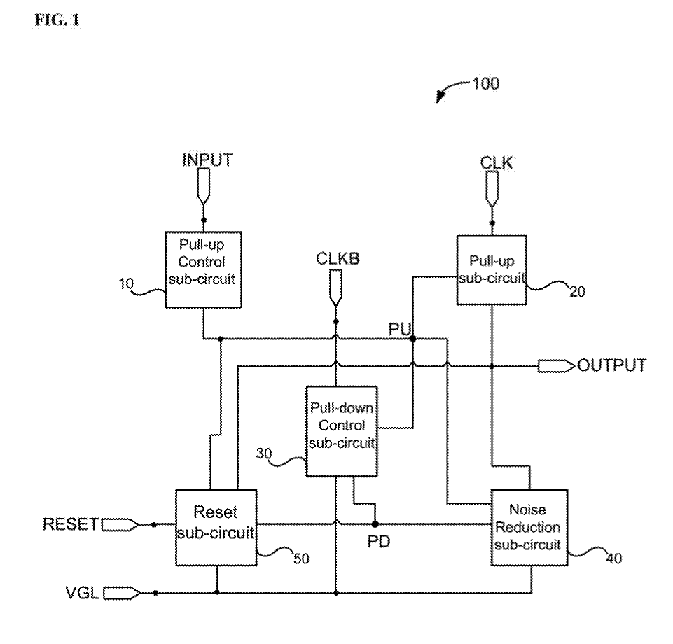

FIG. 1 is a circuit structure diagram of a shift register unit according to some embodiments. The shift register unit circuit 100 includes at least an input port INPUT, an output port OUTPUT, a reset port RESET, a pull-up node PU, a pull-down node PD, a pull-up control sub-circuit 10, a pull-up sub-circuit 20, a pull-down control sub-circuit 30, a noise-reduction sub-circuit 40, and a reset sub-circuit 50.

In some embodiments, the pull-up control sub-circuit 10 connects the input port INPUT and the pull-up node PU and is configured, under the control of a voltage signal at the input port INPUT, to output the voltage signal to the pull-up node PU. Depending on which stage is disposed for the present shift register unit in a gate drive circuit (to be shown below), the voltage signal at the input port may be provided from an external source or from a previous adjacent stage of shift register unit circuit.

In some embodiments, the pull-up sub-circuit 20 connects the pull-up node PU, a first clock input port CLK, and the output port OUTPUT. Under a control of a potential level at the pull-up node PU the pull-up sub-circuit 20 is configured to output a first clock signal provided at the first clock input port to the output port OUTPUT.

In some embodiments, the pull-down control sub-circuit 30 connects a second clock input port CLKB, the pull-down node PD, and a first-voltage port VGL. Under controls of a voltage signal provided at the second clock input port CLKB and the potential level at the pull-up node PU, the pull-down control sub-circuit 30 is configured to pull down a potential level of the pull-down node PD to a logic low potential provided at the first-voltage port VGL.

In some embodiments, the noise-reduction sub-circuit 40 connects to the pull-down node PD, the pull-up node PU, the output port OUTPUT, and the first-voltage port VGL. The noise-reduction sub-circuit 40 is configured, under a control of the potential level at the pull-down node PD, to pull down respective potential levels at the pull-up node PU and the output port OUTPUT to a logic low potential provided at the first-voltage port VGL.

In some embodiments, the reset sub-circuit 50 connects to a reset port RESET, the pull-up node PU, the output port OUTPUT, and the first-voltage port VGL. The reset sub-circuit 50 is configured, under a control of a reset signal set at the reset port RESET, to respectively pull down potential levels at the pull-up node PU and the output port OUTPUT to a logic low potential provided at the first-voltage port VGL.

The shift register unit circuit 100 is used as a single stage of a gate drive circuit (to be shown below) of a display apparatus for providing a gate drive signal outputted to a gate line for controlling a row of image pixels built in a display panel based on preset image data in one of a plurality of display cycles. A system controller of the display apparatus shall provide at least a start voltage signal STV used as an input signal received by the input port, a first clock signal CLK1 provided at the first clock input port CLK, a second clock signal CLK2 provided at the second clock input port CLKB, and a voltage signal VGL provided at the first-voltage port VGL, which are selectively supplied with logic low or high potential levels depending on different periods in each display cycle based on specific control scheme. The voltage signal VGL usually is set to a fixed logic low potential level.

Within one display cycle, the shift register unit 100 uses the pull-up control sub-circuit 10 to control setting a potential level at the pull-up node PU. The potential level at the pull-up node further controls the pull-up sub-circuit 20 to pass the first clock signal provided at the first clock input port CLK to the output port OUTPUT. The output port OUTPUT then in an output period of the display cycle correspondingly outputs a gate drive signal to a gate line that is connected to the output port. In addition, the shift register unit 100 uses the pull-down control sub-circuit 30 to control setting a potential level at the pull-down node PD. The potential level at the pull-down node PD then is used to control the reset sub-circuit 50 to pull down potential levels of the pull-up node PU and the output port OUTPUT to the logic low potential provided at the first-voltage port VGL to reset the potential levels at the pull-up node PU and the output port OUTPUT. Before entering a next display cycle, the shift register unit 100 uses the potential level at the pull-down node PD to control the noise-reduction sub-circuit 40 to persistently pull down potential levels of the pull-up node PU and the output port OUTPUT to the logic low potential provided at the first-voltage port VGL so that the voltages at the pull-up node PU and the output port OUTPUT are released to reduce noise level at the output port. In other words, the shift register unit 100 will maintain a state without output signal during all non-output periods of each display cycle to raise a signal-to-noise ratio of the output signal and circuit stability of at least a current stage of the gate drive circuit made by the present shift register unit 100.

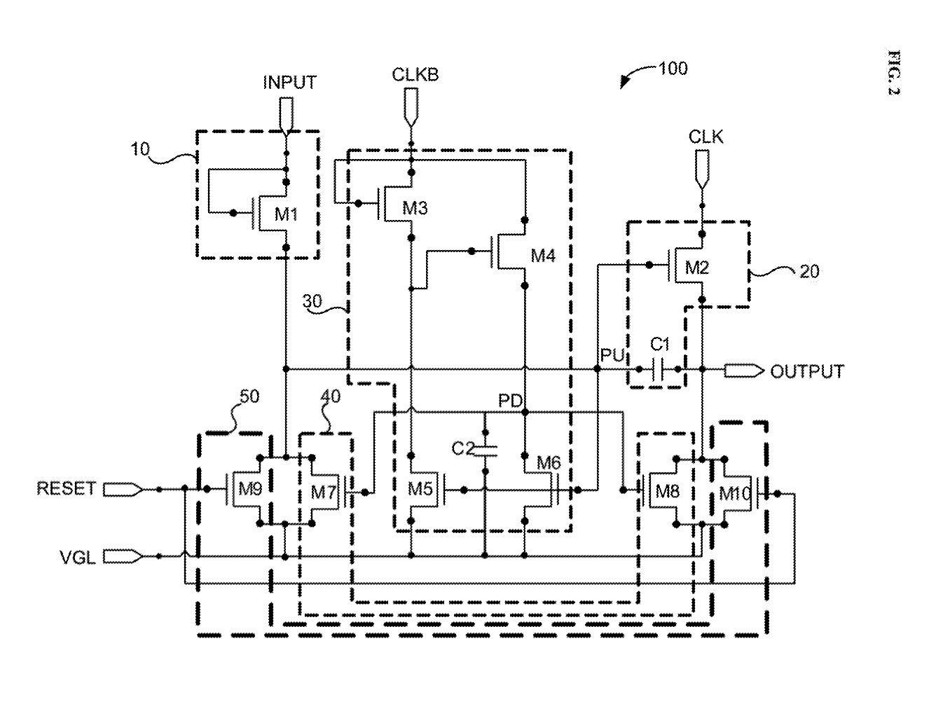

FIG. 2 is a circuit diagram of the shift register unit showing corresponding sub-circuits according to a specific embodiment. Referring to FIG. 2, the pull-up control sub-circuit 10 includes a first transistor M1. In an example, M1 is a thin-film transistor having a gate and a first terminal connected to the input port INPUT of the shift register unit 100. M1 also has a second terminal connected to the pull-up node PU. The pull-up sub-circuit 20 includes a second transistor M2 and a first capacitor C1. M2 can be made by a thin-film transistor and C1 can be a capacitor layer built nearby. M2 has a gate connected to the pull-up node PU, a first terminal connected to the first clock input port CLK, and a second terminal connected to the output port OUTPUT. C1 has one of two terminals connected to the pull-up node PU and another terminal connected to the output port OUTPUT.

Referring to FIG. 2, the pull-down control sub-circuit 30 includes a third transistor M3, a fourth transistor M4, a fifth transistor M5, a sixth transistor M6, and a second capacitor C2. M3 has a gate and a first terminal connected to the second clock input port CLKB, and a second terminal connected to a gate of the fourth transistor M4. M4 further has a first terminal connected to the second clock input port CLKB and a second terminal connected to the pull-down node PD. M5 has a gate connected to the pull-up node PU, a first terminal connected to the second terminal of M3, and a second terminal connected to the first-voltage port VGL. The sixth transistor has a gate connected to the pull-up node PU, a first terminal connected to the pull-down node PD, and a second terminal connected to the first-voltage port VGL. The second capacitor C2 has one terminal connected to the pull-down node PD and another terminal connected to the first-voltage port VGL. Optionally, the pull-down control sub-circuit 30 includes multiple capacitors mutually connected in parallel to the second capacitor C2.

Referring to FIG. 2, the noise-reduction sub-circuit 40 includes a seventh transistor M7 and an eighth transistor M8. M7 has a gate connected to the pull-down node PD, a first terminal connected to the pull-up node PU, and a second terminal connected to the first-voltage port VGL. M8 has a gate connected to the pull-down node PD, a first terminal connected to the output port OUTPUT, and a second terminal connected to the first-voltage port VGL. Additionally, the reset sub-circuit 50 includes a ninth transistor M9 and a tenth transistor M10. M9 has a gate connected to the reset port RESET, a first terminal connected to the output port OUTPUT, and a second terminal connected to the first-voltage port VGL.

Referring to FIG. 2, all transistors mentioned above can be made by N-type transistors. Optionally, all transistors mentioned above can be made by P-type transistors. Optionally, all transistors mentioned above can be made by enhancement-mode thin-film transistors. Optionally, all transistors mentioned above can be made by depletion-mode thin-film transistors. Optionally, the first terminal of each transistor can be a source node and the second terminal correspondingly is a drain node. Optionally, they can be reversed with the first terminal being a drain node and the second terminal being a source node. The present invention is substantially illustrated in the disclosure using N-type transistors for all transistors in the shift register unit circuit, though the invention is applicable for all transistors in P-type.

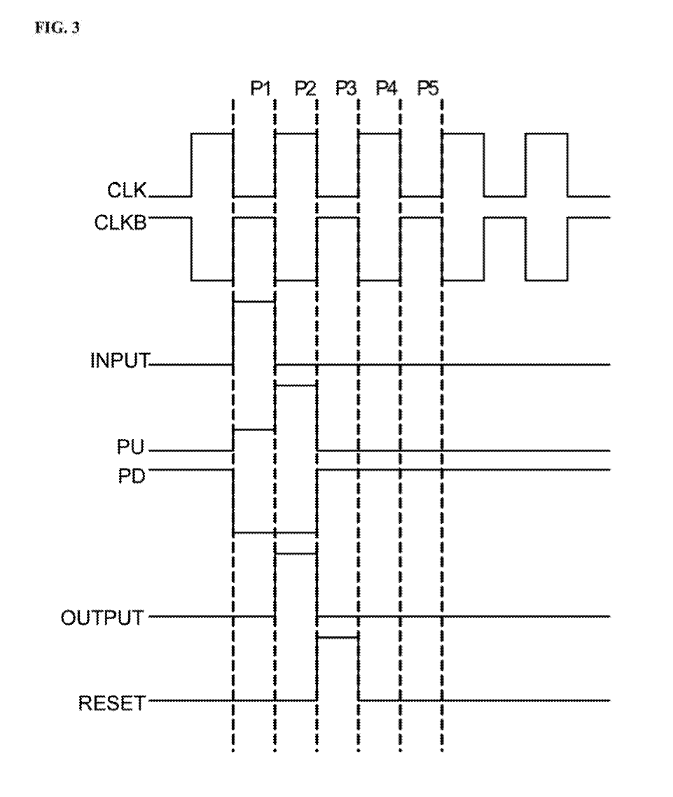

FIG. 3 is a timing diagram for operating the shift register unit of FIG. 2 in one display cycle according to some embodiments. Here, it is assumed that all transistors used in FIG. 2 are N-type transistors. If P-type transistors are used all control signals shown in FIG. 3 may be reversed, though the operation principle of the present invention remains applicable in all aspects. Referring FIG. 3, in one display cycle various control signals and node potentials are depicted to show the operation of the shift register unit in different periods of the display cycle. The voltage signal VGL is assumed to be set to a fixed logic low potential level throughout the display cycle.

In an input period P1, FIG. 3 shows that signals INPUT=1, RESET=0, CLK=0, CLKB=1; where “0” represents logic low potential and “1” represents logic high potential. Theoretically, a logic low potential is a voltage to be applied to a gate of a thin-film transistor to make it in an off-state or a blocking-state for blocking a current flowing from a first terminal to a second terminal thereof. Conversely, a logic high potential is a voltage to be applied a gate of a thin-film transistor to make it in an on-state or a conduction state for allowing a current flowing from a first terminal to a second terminal thereof.

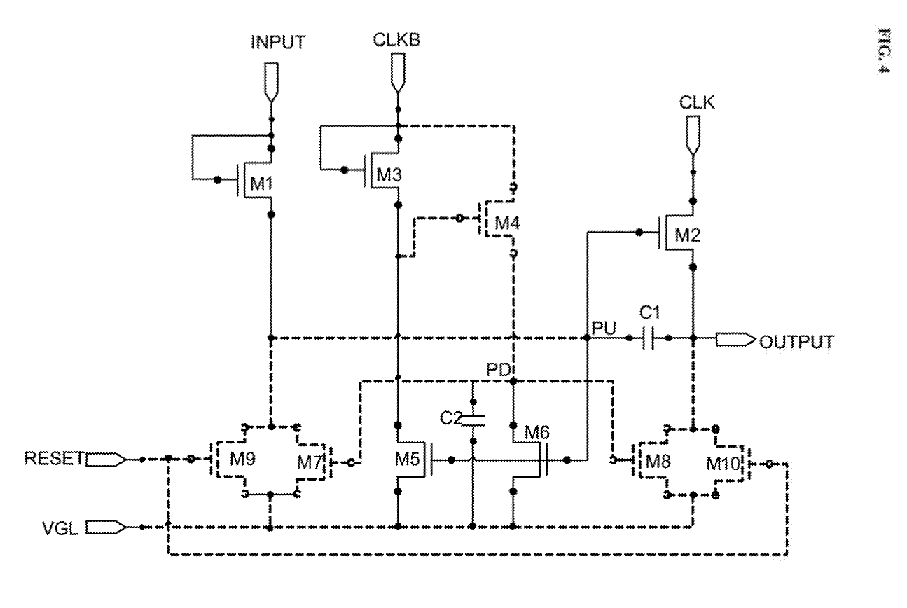

Referring the input period P1, an equivalent circuit of the shift register unit 100 is shown in FIG. 4. Because that a logic high potential is provided (from system controller) at the input port INPUT, the first transistor M1 is turned on as a conductor so that the logic high potential is outputted from the input port INPUT to the pull-up node PU and stored in the first capacitor C1. Under a control of the pull-up node PU which is now at logic high potential, the second transistor M2 is turned on so that logic low potential is outputted from the first clock input port CLK (which is connected to external first clock signal supply CLK1) to the output port OUTPUT.

Additionally, controlled by logic high potential level at the pull-up node PU, the fifth transistor M5 and the sixth transistor M6 are turned on. Conducting M5 will pull down a potential level outputted at the second terminal of M3 to a logic low potential set at the first-voltage port VGL, even though logic high potential provided at the second clock input port CLKB (from external second clock signal supply CLK2) causes M3 to be in an on-state to pass a logic high potential to the second terminal of M3. Therefore, the fourth transistor M4 will be in an off-state without causing the potential level at pull-down node PD to be raised to logic high level.

Because the sixth transistor M6 is in an on-state, the potential level at the pull-down node PD is pulled down to the logic low potential set at the first-voltage port VGL. Now, the seventh transistor M7 and the eighth transistor M8 are all kept at an off-state. Also, because the reset port RESET is set to logic low potential, the ninth transistor M9 and the tenth transistor M10 are all kept at off-state. In general, the output port OUTPUT outputs a signal with a logic low potential in the input period P1.

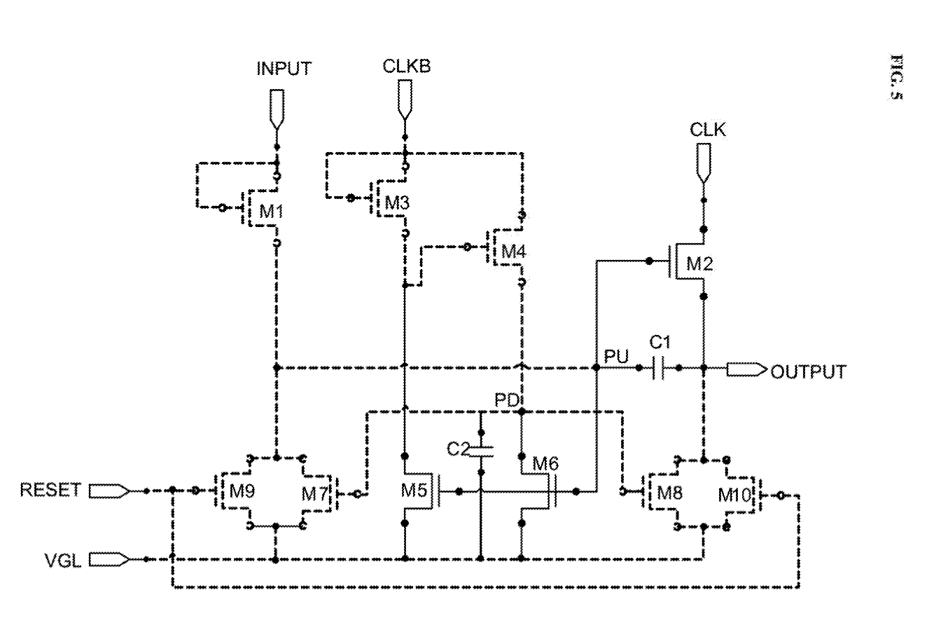

In an output period P2, signals INPUT=0, RESET=0, CLK=1, CLKB=0. An equivalent circuit of the shift register unit 100 in the output period P2 is shown in FIG. 5. As the input port is provided with logic low potential, the first transistor M1 is set to a blocking state or off-state. The first capacitor C1 charges the pull-up node PU using the logic high potential stored during the input period P1 to make the second transistor M2 in an on-state. Then, the first clock signal with logic high potential at the first clock input port CLK is passing through M2 to reach the output port OUTPUT. In addition, due to bootstrapping effect of the first capacitor C1, the pull-up node potential level in this output period P2 is pushed higher than that in the input period P1 so that the second transistor M2 is maintained in on-state. Therefore, the logic high potential provided at the first clock input port CLK will be passed through M2 to be outputted to the output port OUTPUT, which is further outputted to a gate line as a gate drive signal.

Referring to FIG. 5, the pull-up node PU at logic high potential controls the fifth transistor M5 and the sixth transistor M6 to be in an on-state. Conducting M6 will pull down the potential level of the pull-down node PD to the logic low potential VGL set at the first-voltage port VGL. Similar to the input period P1, the seventh transistor M7 and the eighth transistor M8 are is an off-state. Since the reset port RESET is set at logic low potential, M9 and M10 are also set to an off-state. The second clock signal provided at the second clock input port CLKB is provided with logic low potential, making M3 and M4 in an off-state. In general, the output port OUTPUT is designed to output a logic high voltage signal during the output period P2. The output port OUTPUT is connected to a gate line so that a gate drive signal is provided to the gate line for driving a row of pixels.

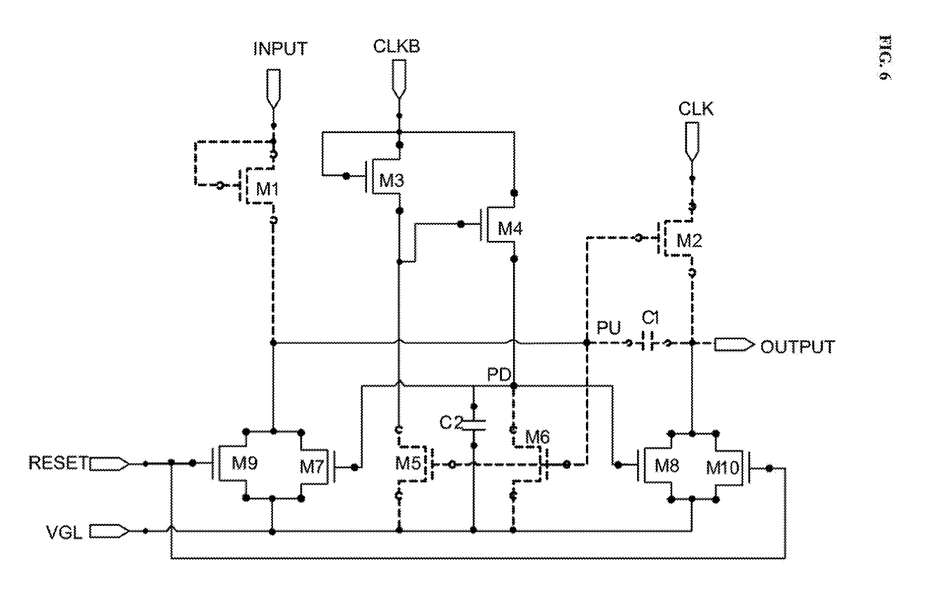

Referring back to FIG. 3, in a reset period P3, signals INPUT=0, RESET=1, CLK=0, CLKB=1; leading to an equivalent circuit of the shift register unit 100 shown in FIG. 6. Logic high potential at RESET makes M9 and M10 in an on-state. Through M9, the potential level at the pull-up node PU is pulled down to logic low potential VGL set at the first-voltage port VGL so that the pull-up node potential is reset. Through M10, the potential level at the output port OUTPUT is pulled down to logic low potential VGL set at the first-voltage port VGL so that the output port OUTPUT potential is reset.

In addition, logic high potential at the second clock input port CLKB makes M3 in an on-state which subsequently passes the logic high potential from the CLKB to the gate of M4. So, M4 is turned on and the logic high potential at CLKB is passed to the pull-down node PD and further is stored in the second capacitor C2.

The logic high potential at the pull-down node PD controls the seventh transistor M7 and the eighth transistor M8 to be in an on-state. Through M7, the potential level at the pull-up node PU is pulled down to logic low potential VGL set at the first-voltage port VGL so as to reduce noise level at the pull-up node PU. Through M8, the potential level at the output port OUTPUT is pulled down to logic low potential VGL set at the first-voltage port VGL so as to reduce noise level at the output port OUTPUT.

In addition, because of the pull-up node PU potential is pulled down, M2, M5, and M6 are all set to an off-state in the reset period P3.

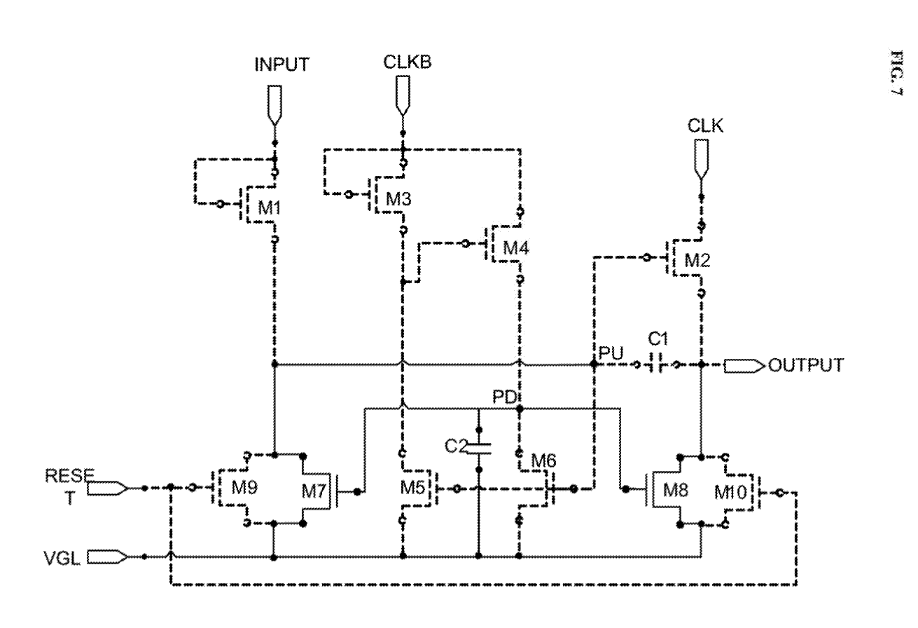

In a noise-reduction period P4, signals INPUT=0, RESET=0, CLK=1, CLKB=0, leading to an equivalent circuit of the shift register unit 100 shown in FIG. 7. In particular, the second capacitor C2 outputs the logic high potential stored during the reset period P3 to the pull-down node PD in this noise-reduction period P4. The logic high potential at the pull-down node PD makes M7 and M8 in an on-state. Through M7, the potential level at the pull-up node PU is pulled down to logic low potential VGL set at the first-voltage port VGL so as to reduce noise level at the pull-up node PU. Through M8, the potential level at the output port OUTPUT is pulled down to logic low potential VGL set at the first-voltage port VGL so as to reduce noise level at the output port OUTPUT. Except that M7 and M8 are in on-states, all other transistors in the noise-reduction period are in off-states.

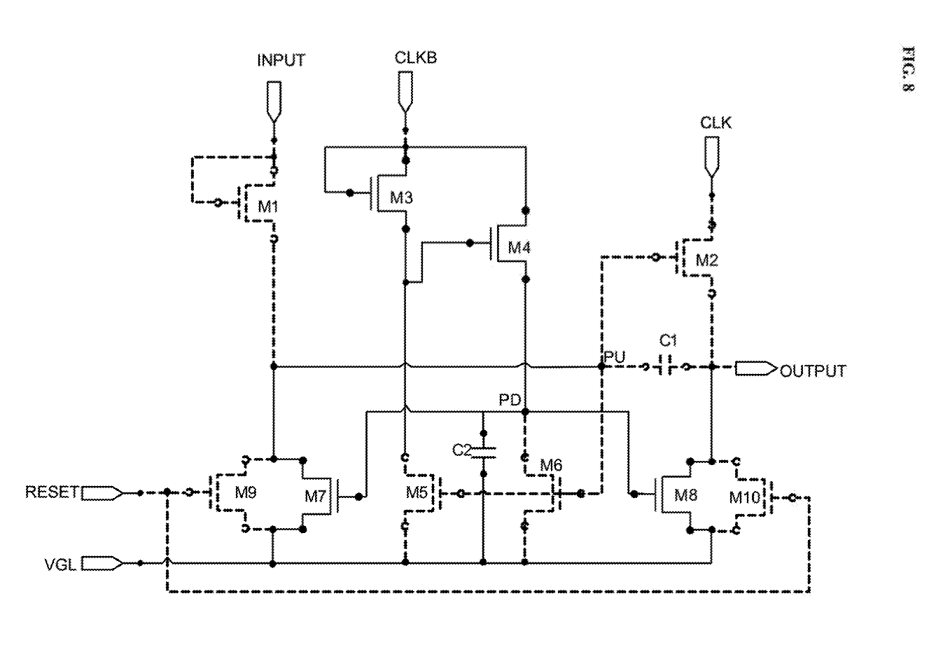

In a noise-maintaining period P5, signals INPUT=0, RESET=0, CLK=0, CLKB=1, leading to an equivalent circuit of the shift register unit 100 shown in FIG. 8. In particular, the logic high potential provided at the second clock input port CLKB makes M3 in an on-state so that the logic high potential at CLKB is passed through M3 to the gate of M4, making M4 to a conduction state. Then, the logic high potential at CLKB is also passed through M4 to reach the pull-down node PD. The logic high potential then is stored to the second capacitor C2 which is connected to the pull-down node PD.

Under the control of logic high potential at the pull-down node PD, M7 and M8 are turned on. Through M7, the potential level at the pull-up node PU is pulled down to logic low potential VGL set at the first-voltage port VGL so as to reduce noise level at the pull-up node PU. Through M8, the potential level at the output port OUTPUT is pulled down to logic low potential VGL set at the first-voltage port VGL so as to reduce noise level at the output port OUTPUT.

In some embodiments, each display cycle may contain an extended time after the noise-maintaining period P5 before entering a next display cycle. Then in this scenario, the present invention can set to repeat supplies of the INPUT, RESET, CLK, and CLKB signals, at least once, in one noise-reduction period P4′ followed by one noise-maintaining period P5′ before the next display cycle starts. Thus in the complete time periods of each display cycle, the shift register unit 100 is configured to keep the noise level low during any non-output periods to enhance overall signal-to-noise ratio and maintain circuit stability all the time.

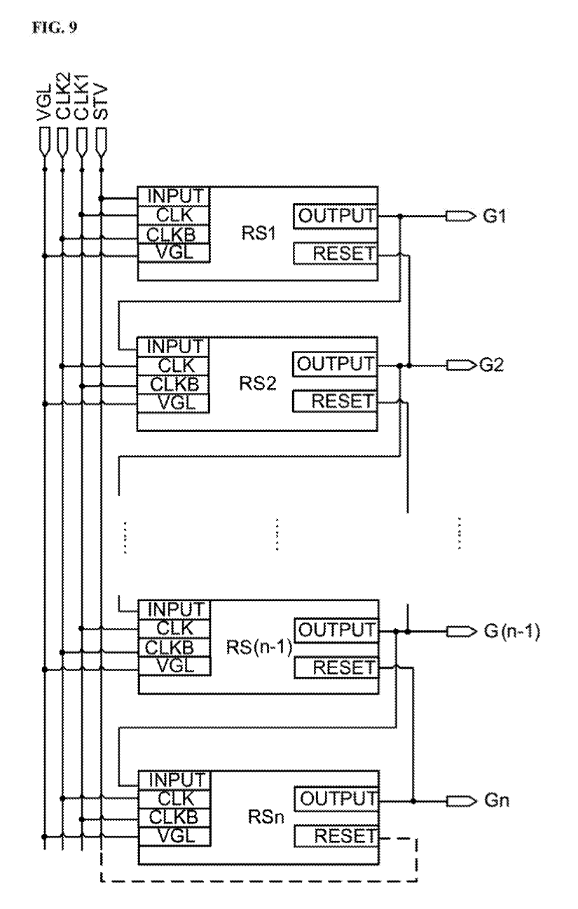

Accordingly, the present invention provides, inter alia, a gate drive circuit, a display panel and a display apparatus having the plurality of same shift register units cascaded in multiple stages, and a method for driving the shift register unit thereof that substantially obviate one or more of the problems due to limitations and disadvantages of the related art. In one aspect, a gate drive circuit is provided as shown in FIG. 9, including multi-stage cascaded shift register units, RS1, RS2, . . . , RSn, each of which is just substantially the same as the shift register unit 100 described in FIG. 1 and specifically in FIG. 2.

In some embodiments, the shift register unit in the first stage RS1 has an input port connected to a start terminal STV to receive a corresponding input signal STV. Except the shift register unit in the first stage RS1, for each shift register unit at a current stage, RS(n), the input port INPUT connects to the output port OUTPUT of the shift register unit at the previous adjacent stage, RS(n−1). In other words, the INPUT signal is merely an OUTPUT signal of a previous adjacent stage. Except the shift register unit in the last state RSn, each shift register unit at a current stage, RS(n), has a reset port connecting to the output port OUTPUT of the shift register unit at the next adjacent stage, RS(n+1). In other words, the RESET signal is merely an OUTPUT signal from a shift register unit at the previous adjacent stage. The reset port of the shift register unit at the last stage RSn receives a RESET signal externally. Optionally, the RESET signal received by the last stage is substantially the same as the start signal STV by connecting the reset port to the start terminal STV. When the start terminal STV sends an INPUT signal to the input port of the shift register unit at the first stage RS1, the reset port of the shift register unit at the last stage RSn also receives this STV signal as a RESET signal to reset potential level at the output port OUTPUT thereof.

In some embodiments, the gate drive circuit optionally includes a phase inverter 90 connected to the reset port of the shift register unit at the last stage RSn. In particular, the phase inverter 90 has a first input receiving an output signal from the output port of the shift register unit circuit in the last stage RSn−1 and a second input receiving a logic low potential VGL provided at the first-voltage port. The phase inverter is configured to output a reset signal to the reset port RESET of the shift register unit circuit in the last stage RSn, the reset signal being inverted in phase versus the output signal for resetting the output port OUTPUT of the shift register unit circuit in the last stage RSn. Therefore, when the output port OUTPUT of the shift register unit circuit in the last stage RSn outputs a logic high potential signal, the reset port of RSn receives a logic low potential. Conversely, when the output port OUTPUT of the shift register unit circuit in the last stage RSn outputs a logic low potential signal, the reset port of RSn receives a logic high potential. This logic high potential can be used to reset the potential level at the output port OUTPUT of the shift register unit circuit in the last stage RSn.

In some embodiments, the first clock signal and the second clock signal provided at the first clock input port CLK and the second clock input port CLKB of each shift register unit is the same in frequency and amplitude but reverse in phase in each period of a full display cycle as shown in FIG. 3.

In some embodiments, as shown in FIG. 9, in order to maintain that the first clock signal at the first clock input port and the second clock signal at the second clock input port of the shift register unit in each stage is the same in frequency and amplitude but reverse in phase, different first clock input port and second clock input port from different shift register units can be alternatively connected to a first system clock terminal CLK1 and a second system clock terminal CLK2. For example, the first clock input port CLK of the shift register unit at the first stage RS1 connects to the first system clock terminal CLK1 and the corresponding second clock input port CLKB connects to the second system clock terminal CLK2. The first clock input port CLK of the shift register unit at the second stage RS2 connects to the second system clock terminal CLK2 and the corresponding second clock input port CLKB connects to the first system clock terminal CLK1, and so on.

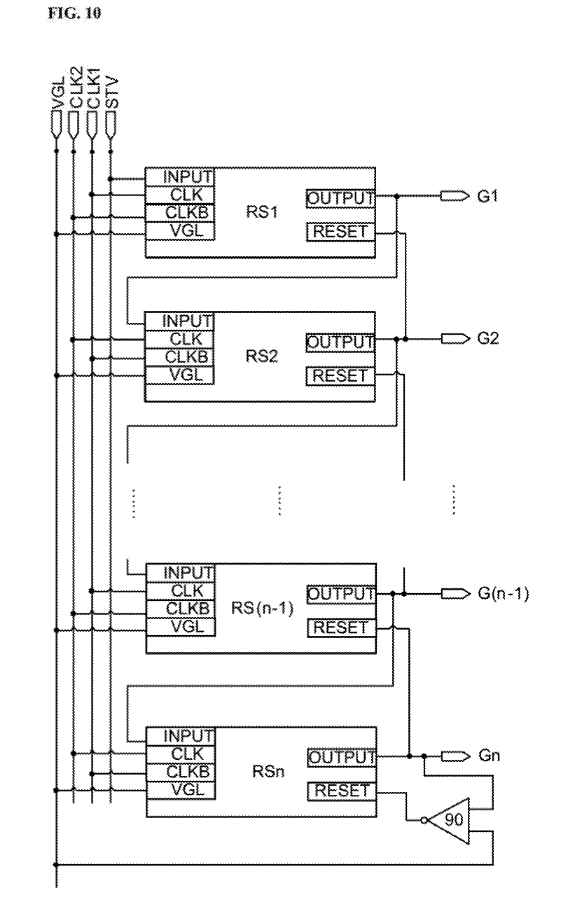

In an alternative aspect, the present disclosure provides a display apparatus including the gate drive circuit described above in FIG. 9 or FIG. 10.

In another alternative aspect, the present disclosure provides a method for driving the shift register unit described above in FIG. 1 through FIG. 8. The method is for generating a gate drive signal at the output port of the shift register unit in each image display cycle including sequentially an input period, an output period, a reset period, a noise-reduction period, and a noise-maintaining period. In particular, in the input period P1 as shown in FIG. 3, the method includes using an input signal provided with a logic high potential at the input port in the input period to control the pull-up control sub-circuit to output the logic high potential to the pull-up node, storing the logic high potential in a first capacitor of the pull-up sub-circuit, and using the logic high potential at the pull-up node in the input period to control the pull-up sub-circuit to output the first clock signal at a logic low potential from the first clock input port to the output port. Under the control of the input signal from the input port INPUT, the pull-up control sub-circuit 10 (of FIG. 1) outputs the input signal to the pull-up node PU. The input signal is a logic high potential and is stored in the first capacitor by the pull-up sub-circuit 20 and is used to control outputting the first clock signal from the first clock input port CLK to the output port OUTPUT. The pull-down control sub-circuit 30, under the control of the second clock signal from the second clock input port CLKB and the logic high potential at the pull-up node PU, pulls down the potential level at the pull-down node PD to the logic low potential set at the first-voltage port VGL. The noise-reduction sub-circuit 40 and the reset sub-circuit 50 are not enabled in this input period P1.

As shown in FIG. 3, in the input period P1, the first clock input port CLK is provided with a logic low potential. The second clock input port CLKB is provided with a logic high potential. The input port INPUT is inputted with a logic high potential. Correspondingly, the pull-up node PU is set to logic high potential. The pull-down node PD is set to logic low potential. The output port OUTPUT outputs a signal with logic low potential.

In the output period P2, the method further includes using the logic high potential stored at the first capacitor to charge up the pull-up node PU to a higher logic high potential to control the pull-up sub-circuit 20 to output the first clock signal at a logic high potential from the first clock input port CLK to the output port OUTPUT and outputting a logic high potential as the gate drive signal from the output port. As shown in FIG. 3, the pull-up sub-circuit 20 outputs the logic high potential stored in the first capacitor (in the period P1) to the pull-up node PU for controlling a passage of the first clock signal from the first clock input port CLK to the output port OUTPUT. The first capacitor pushes the potential at the pull-up node PU even higher to ensure the output port OUTPUT receiving the logic high potential from the port CLK and further output to the gate line as a gate drive signal. In this period, the pull-down control sub-circuit 30 is controlled by the potentials at the second clock input port CLKB and the pull-up node PU to pull down the potential of the pull-down node PD to a logic low potential preset by the first-voltage port VGL. The noise-reduction sub-circuit 40 and the reset sub-circuit 50 are not enabled and the pull-up sub-circuit 10 has no output in this period.

Referring again to FIG. 3, the first clock provided at the first clock input port CLK is a logic high potential and the second clock signal provided at the second clock input port CLKB is a logic low potential, reversed in phase. The input port INPUT receives a logic low potential signal. Accordingly, node PU is set to logic high potential, node PD is set to logic low potential, and the output port OUTPUT outputs a logic high potential signal.

In the reset period P3, the method additionally includes using the second clock signal at a logic high potential provided at the second clock input port CLKB and a logic low potential at the pull-up node PU to control the pull-down control sub-circuit 30 to output a logic high potential from the second clock input port CLKB to the pull-down node PD. The method further includes storing the logic high potential associated with the second clock signal in a second capacitor of the pull-down control sub-circuit 30. Furthermore, the method includes using the stored logic high potential at the pull-down node PD to control the noise-reduction sub-circuit 40 to respectively pull down the pull-up node PU and the output port OUTPUT to a logic low potential provided at the first-voltage port VGL and using a reset signal at a logic high potential provided at the reset port RESET in the reset period to control the reset sub-circuit 50 to respectively pull down the pull-up node PU and the output port OUTPUT to the logic low potential provided at the first-voltage port VGL.

Referring back to FIG. 3, the pull-down control sub-circuit passes the second clock signal at logic high potential from port CLKB to the node PD under the control of the second clock signal itself as well as the potential at the node PU. The logic high potential is then stored in the second capacitor. The noise-reduction sub-circuit 40 pulls down both the node PD and output port OUTPUT to the logic low potential VGL. The reset sub-circuit 50 pulls down both node PU and the output port OUTPUT also to logic low potential VGL by the reset signal. No outputs from the pull-up control sub-circuit 30 and the pull-up sub-circuit 10 and no output signal from the output port OUTPUT in the reset period P3.

Referring to FIG. 3, the first clock signal reverses again to a logic low potential provided at the first clock input port CLK and the second clock signal is a logic high potential signal given at the second clock input port CLKB. The input signal is given at the input port INPUT as a logic low potential signal. Node PU is accordingly set to logic low potential. Node PD is set to logic high potential. The output port OUTPUT outputs a logic low potential signal.

In the next noise-reduction period P4, the method further includes outputting the logic high potential stored in the second capacitor to the pull-down node PD. The method again includes using the logic high potential at the pull-down node PU to control the noise-reduction sub-circuit 40 to respectively pull down the pull-up node PU and the output port OUTPUT to the logic low potential VGL provided at the first-voltage port. The pull-up control sub-circuit 10 and the pull-up sub-circuit 20 has no output signals. The output port OUTPUT outputs no logic high voltage signal and the reset sub-circuit 50 does not started yet. FIG. 3 shows that the first clock signal at CLK is a logic high potential, the second clock signal at CLKB is a logic low potential, and the INPUT signal is a logic low potential. Further, the node PU is correspondingly set to logic low potential, the node PD is set to logic high potential. Therefore, the pull-up node PU and the output port OUTPUT are placed to low potential to raise signal-to-noise ratio in the noise-reduction period P4.

In the next noise-maintaining period P5, the method furthermore includes using the second clock signal at a logic high potential provided at the second clock input port CLKB and a logic low potential at the pull-up node PU to control the pull-down control sub-circuit 30 to output the logic high potential associated with the second clock signal from the second clock input port CLKB to the pull-down node PD. Moreover, the method includes storing the logic high potential in the second capacitor and using the logic high potential at the pull-down node to control the noise-reduction sub-circuit 40 to respectively pull down the pull-up node PU and the output port OUTPUT to the logic low potential provided at the first-voltage port VGL. As shown in FIG. 3, the first clock signal at CLK is logic low potential, the second clock signal at CLKB is logic high potential, the INPUT signal is logic low potential, the pull-up node PU is accordly set to logic low potential, the pull-down node PD is set to logic high potential, and the output port OUTPUT provides a logic low potential or basically no signal to the gate line. This setup helps to maintain noise levels low for the pull-up node PU and the output port OUTPUT.

As a single display cycle may not be finished after the noise-maintaining period P5, the method optionally also includes repeating supplies of the input signal, the reset signal, the first clock signal, and the second clock signal at respective logic low or high potentials in a noise-reduction period followed by a subsequent noise-maintaining period before a next display cycle to maintain the output port at a state without outputting the gate drive signal. In other words, after the last noise-maintaining period P5, another noise-reduction period P4′ may be included with substantially the same potential levels (or phases) as those INPUT signal, RESET signal, CLK signal, and CLKB signal. Further another noise-maintaining period P5′ with substantially the same signals as those in period P5 may be placed next to the P4′, and optionally to repeat more before a next display cycle is introduced. The repeated P4 and P5 periods after the reset period P3 is aimed to continuously keep the node PU and the output port OUTPUT at low potential level so as to keep the noise level low thereof. No output signal is passed to the gate line during these periods of any display cycle.

Within one display cycle, the method employs the pull-up control sub-circuit 10 of the shift register unit 100 to control setting a potential level at the pull-up node PU and further to control the pull-up sub-circuit 20 to pass the first clock signal provided at the first clock input port CLK to the output port OUTPUT. The method allows that the output port OUTPUT only in an output period correspondingly outputs a gate drive signal to a gate line that is connected to the output port. In addition, the method uses the pull-down control sub-circuit 30 of the shift register unit 100 to set a potential level at the pull-down node PD which is further used to control the reset sub-circuit 50 to pull down potential levels of the pull-up node PU and the output port OUTPUT to the logic low potential provided at the first-voltage port VGL. This operation resets the potential levels at the pull-up node PU and the output port OUTPUT. Before entering a next display cycle, the method uses the potential level at the pull-down node PD to control the noise-reduction sub-circuit 40 of the shift register unit 100 to persistently pull down potential levels of the pull-up node PU and the output port OUTPUT to the logic low potential VGL so that the voltages at the pull-up node PU and the output port OUTPUT are released and noise levels thereof are reduced. In other words, the method maintains the output port at a state without output signal during all non-output periods of each display cycle to raise a signal-to-noise ratio of the output signal and circuit stability of the shift register unit circuit as well as the entire gate drive circuit, further enhancing image quality of the display apparatus that includes the gate drive circuit.

The foregoing description of the embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

1. A shift register unit circuit having an input port, a pull-up node, and an output port, further comprising:
a pull-up control sub-circuit connected to the input port and the pull-up node and configured to be controlled by an input signal at the input port to output the input signal from the input port to the pull-up node to set a potential level at the pull-up node;
a pull-up sub-circuit connected to the pull-up node, a first clock input port, and the output port and configured to be controlled by the potential level at the pull-up node to output a first clock signal from the first clock port to the output port;
a pull-down control sub-circuit connected to a second clock input port, a pull-down node, and a first-voltage port and configured to be controlled by a second clock signal at the second clock input port and the potential level at the pull-up node to pull down a potential level at the pull-down node to a first voltage provided at the first-voltage port;
a noise-reduction sub-circuit connected to the pull-down node, the pull-up node, the output port, and the first-voltage port and configured to pull down potential levels at the pull-up node and the output port to the first voltage;
a reset sub-circuit connected to a reset port, the pull-up node, the output port, and the first-voltage port and configured to be controlled by a reset signal at the reset port to pull down the potential levels at the pull-up node and the output port to the first voltage;
wherein the pull-up control sub-circuit comprises a first transistor having a gate and a first terminal commonly connected to the input port and a second terminal connected to the pull-up node.

2. The shift register unit circuit of claim 1, wherein the pull-down control sub-circuit comprises a third transistor, a fourth transistor, a fifth transistor, a sixth transistor, and a second capacitor;
the third transistor having a gate and a first terminal commonly connected to the second clock input port, and a second terminal connected to a gate of the fourth transistor;
the fourth transistor having a first terminal connected to the second clock input port and a second terminal connected to the pull-down node;
the fifth transistor having a gate connected to the pull-up node, a first terminal connected to the second terminal of the third transistor, and a second terminal connected to the first-voltage port;
the sixth transistor having a gate connected to the pull-up node, a first terminal connected to the pull-down node, and a second terminal connected to the first-voltage port; and
the second capacitor having one terminal connected to the pull-down node and another terminal connected to the first-voltage port.

3. The shift register unit circuit of claim 1, wherein the pull-up sub-circuit comprises a second transistor and a first capacitor, the second transistor having a gate connected to the pull-up node, a first terminal connected to the first clock input port, and a second terminal connected to the output port, the first capacitor having one terminal connected to the pull-up node and another terminal connected to the output port.

4. The shift register unit circuit of claim 1, wherein the noise reduction sub-circuit comprises a seventh transistor and an eighth transistor; the seventh transistor having a gate connected to the pull-down node, a first terminal connected to the pull-up node, and a second terminal connected to the first-voltage port; the eighth transistor having a gate connected to the pull-down node, a first terminal connected to the output port, and a second terminal connected to the first-voltage port.

5. The shift register unit circuit of claim 1, wherein the reset sub-circuit comprises a ninth transistor and a tenth transistor, the ninth transistor having a gate connected to the reset port, a first terminal connected to the pull-up node, and a second terminal connected to the first-voltage port; the tenth transistor having a gate connected to the reset port, a first terminal connected to the output port, and a second terminal connected to the first-voltage port.

6. The shift register unit circuit of claim 1, wherein the first clock input port and the second clock input port respectively receive a first clock signal and a second clock signal, the second clock signal being configured to be same in frequency and amplitude as the first clock signal but reverse in phase in multiple periods of a display cycle.

7. A gate drive circuit comprising a plurality of the shift register unit circuits of claim 1 cascaded one after another in multiple stages from a first stage to a last stage, wherein the shift register unit circuit in the first stage includes an input port configured to receive a start signal; wherein the shift register unit circuit in each corresponding stage except the first stage includes an input port connected to an output port of a shift register unit circuit in a previous adjacent stage; wherein the shift register unit circuit in each corresponding stage except the last stage includes an output port connected to a reset port of a shift register unit circuit in a next adjacent stage; wherein the shift register unit circuit in the last stage includes a reset port configured to receive a reset signal, wherein the shift register unit in each corresponding stage includes a first clock input port and a second clock input port configured to be alternatively connected to a first system clock terminal and a second system clock terminal.

8. The gate drive circuit of claim 7, wherein the second clock signal is configured to be same in frequency and amplitude as the first clock signal but reverse in phase through a full time span of a display cycle.

9. The gate drive circuit of claim 7, wherein the shift register unit circuit in the last stage includes a reset port configured to receive the start signal.

10. The gate drive circuit of claim 7 further comprising a phase inverter having a first input receiving an output signal from the output port of the shift register unit circuit in the last stage, a second input receiving a logic low potential provided at the first-voltage port, and being configured to output a reset signal to the reset port of the shift register unit circuit in the last stage, the reset signal being inverted in phase versus the output signal for resetting the output port of the shift register unit circuit in the last stage.

11. A display apparatus comprising a gate drive circuit of claim 7.

12. A method for driving the shift register unit circuit of claim 1 for generating a gate drive signal at the output port in a plurality of image display cycles, wherein each display cycle includes sequentially an input period, an output period, a reset period, a noise-reduction period, and a noise-maintaining period, the method comprising:
controlling the pull-up control sub-circuit to output the logic high potential to the pull-up node, using an input signal provided with a logic high potential at the input port in the input period;
storing the logic high potential in a first capacitor of the pull-up sub-circuit;
controlling the pull-up sub-circuit to output the first clock signal at a logic low potential from the first clock input port to the output port, using the logic high potential at the pull-up node in the input period;
controlling the pull-up sub-circuit to output the first clock signal at a logic high potential from the first clock input port to the output port, using the logic high potential stored at the first capacitor to charge up the pull-up node to a higher logic high potential in the output period;
outputting a logic high potential as the gate drive signal from the output port;
controlling the pull-down control sub-circuit to output a logic high potential from the second clock input port to the pull-down node, using a second clock signal at a logic high potential provided at the second clock input port and a logic low potential at the pull-up node in the reset period;
storing the logic high potential associated with the second clock signal in a second capacitor of the pull-down control sub-circuit;
controlling the noise-reduction sub-circuit to respectively pull down the pull-up node and the output port to a logic low potential provided at the first-voltage port, using the stored logic high potential at the pull-down node;
controlling the reset sub-circuit to respectively pull down the pull-up node and the output port to the logic low potential provided at the first-voltage port, using a reset signal at a logic high potential provided at the reset port in the reset period;
outputting the logic high potential stored in the second capacitor to the pull-down node in the noise-reduction period;
controlling the noise-reduction sub-circuit to respectively pull down the pull-up node and the output port to the logic low potential provided at the first-voltage port, using the logic high potential at the pull-down node;
controlling the pull-down control sub-circuit to output the logic high potential associated with the second clock signal from the second clock input port to the pull-down node, using the second clock signal at a logic high potential provided at the second clock input port and a logic low potential at the pull-up node in the noise-maintaining period;
storing the logic high potential in the second capacitor; and
controlling the noise-reduction sub-circuit to respectively pull down the pull-up node and the output port to the logic low potential provided at the first-voltage port, using the logic high potential at the pull-down node.

13. The method of claim 12, further comprising optionally repeating supplies of the input signal, the reset signal, the first clock signal, and the second clock signal at respective logic low or high potentials in a noise-reduction period followed by a subsequent noise-maintaining period before a next display cycle to maintain the output port at a state without outputting the gate drive signal.

14. The method of claim 13, wherein the shift register unit circuit of claim 1 comprises a plurality of thin-film transistors, each thin-film transistor being a N-type transistor, wherein the input period is associated with a logic low potential provided at the first clock input port, a logic high potential provided at the second clock input port, a logic high potential inputted from the input port, wherein in the input period the pull-up node is correspondingly set to a logic high potential, the pull-down node is correspondingly set to a logic low potential, and the output port outputs a logic low potential; wherein any of the logic high potential is configured to be applied to a gate of a corresponding one of the plurality of thin-film transistors to make the corresponding one transistor in an on-state for conducting a current from a first terminal to a second terminal of the transistor, wherein any of the logic low potentials is configured to be applied to a gate of a corresponding one of the plurality of thin-film transistors to make the corresponding one transistor in an off-state for blocking a current from a first terminal to a second terminal of the transistor.

15. The method of claim 14, wherein the output period is associated with a logic high potential provided at the first clock input port, a logic low potential provided at the second clock input port, a logic low potential inputted from the input port, wherein in the output period the pull-up node is correspondingly set to a logic high potential, the pull-down node is correspondingly set to a logic low potential, and the output port outputs a logic high potential as a gate drive signal, wherein the logic high potential in the output period is bootstrapped to be higher than the logic high potential in the input period by the first capacitor of the pull-up sub-circuit.

16. The method of claim 15, wherein the reset period is associated with a logic low potential provided at the first clock input port, a logic high potential provided at the second clock input port, a logic low potential inputted from the input port, wherein in the reset period the pull-up node is correspondingly set to a logic low potential, the pull-down node is correspondingly set to a logic high potential, and the output port outputs a logic low potential.

17. The method of claim 16, wherein the noise-reduction period is associated with a logic high potential provided at the first clock input port, a logic low potential provided at the second clock input port, a logic low potential inputted from the input port, wherein in the noise-reduction period the pull-up node is correspondingly set to a logic low potential, the pull-down node is correspondingly set to a logic high potential, and the output port outputs a logic low potential, wherein the logic high potential at the pull-down node is provided from charges stored in the second capacitor of the pull-down control sub-circuit.

18. The method of claim 17, wherein the noise-maintaining period is associated with a logic low potential provided at the first clock input port, a logic high potential provided at the second clock input port, a logic low potential inputted from the input port, wherein in the noise-reduction period the pull-up node is correspondingly set to a logic low potential, the pull-down node is correspondingly set to a logic high potential, and the output port outputs a logic low potential, wherein the logic high potential at the pull-down node is provided from charges stored in the second capacitor of the pull-down control sub-circuit.
